(19) United States
(12) Patent Application Publication
(10) Pub. No.: US 2004/0031755 A1
(43) Pub. Date: Feb. 19, 2004

(54) Extraction process using water

(76) Inventors: Anthony Alan Clifford, Leeds (GB); Harold John Vandenburg, North Yorkshire (GB)

Correspondence Address: JENKINS & WILSON, PA, 3100 TOWER BLVD, SUITE 1400, DURHAM, NC, 27707, US

(21) Appl. No.: 10/217,929

(22) Filed: Aug. 13, 2002

(51) Int. Cl. B01D 11/00

(52) U.S. Cl. 210/634; 210/639; 426/387

(57) ABSTRACT

The present invention is a method of extracting the oxygen-containing flavor and fragrance compounds from oils obtained from natural products. Extraction is accomplished by the use of cold water typically below 100° C., but more typically below 50° C., to produce a weak aqueous solution. The oxygen-containing compounds are then concentrated by adsorption on to an appropriate solid material and then washed off by an organic solvent, such as ethanol. The resulting product is a solution in the organic solvent.

### BACKGROUND OF THE INVENTION

The present invention involves a process for the extraction of desired compounds, for example flavor and fragrance compounds, from a natural oil.

Typically the natural oil comprises principally substantially water-insoluble hydrocarbon compounds. The desired compounds are typically more soluble in water than the hydrocarbon compounds, albeit still only sparingly soluble.

The separation of compounds that are sparingly soluble in water from a natural oil, obtained for example by pressing or steam distillation, the oil consisting principally of substantially water-insoluble hydrocarbon compounds, is an important industrial process and is often referred to as deterpenation. For example, compounds containing oxygen, which are the important flavor and fragrance compounds, are separated from essential oils, which consist principally (>90% by mass) of monoteipene hydrocarbons. This process is conventionally carried out by counter-current extraction using hexane and ethanol-water mixtures.

In attempts to avoid the use of some conventional organic solvents for environmental reasons and to avoid residues in the products, the use of liquid or supercritical carbon dioxide, and of superheated or subcritical water, has been suggested. Studies of the separation of monoterpenes and oxygen-containing flavor and fragrance compounds by fractionation in supercritical carbon dioxide have been made. Superheated water (that is, i.e. liquid water under pressure above 100° C.) has been shown to preferentially extract the oxygen-containing flavor and fragrance compounds from plants and essential oils, as described in U.S. Pat. Nos. 6,001,256 and 6,352,644. It has been shown that the solubility of liquid organic flavor and fragrance compounds in superheated water increased substantially between 25° C. and 200° C.

The following references describe the background material in detail and are incorporated by reference herein:

McHugh, M. A; Krukonis, V. J., Supercritical Fluid Extraction; Butterworth-Heinemann: Boston, 1994, pp 293-307.

Shibuya, Y.; Ohinata, H.; Yonei, Y.; Ono T., Solvent Extraction in the Process Industries; Vol. 2, Logsdail, D. H.; Slater, M. J., Ed.; Elsevier Applied Science: London, 1993, pp 684-691.

Miller, D. J.; Hawthorne, S. B., Journal of Chemical and Engineering Data, 2000, 45, 315.

### SUMMARY OF THE INVENTION

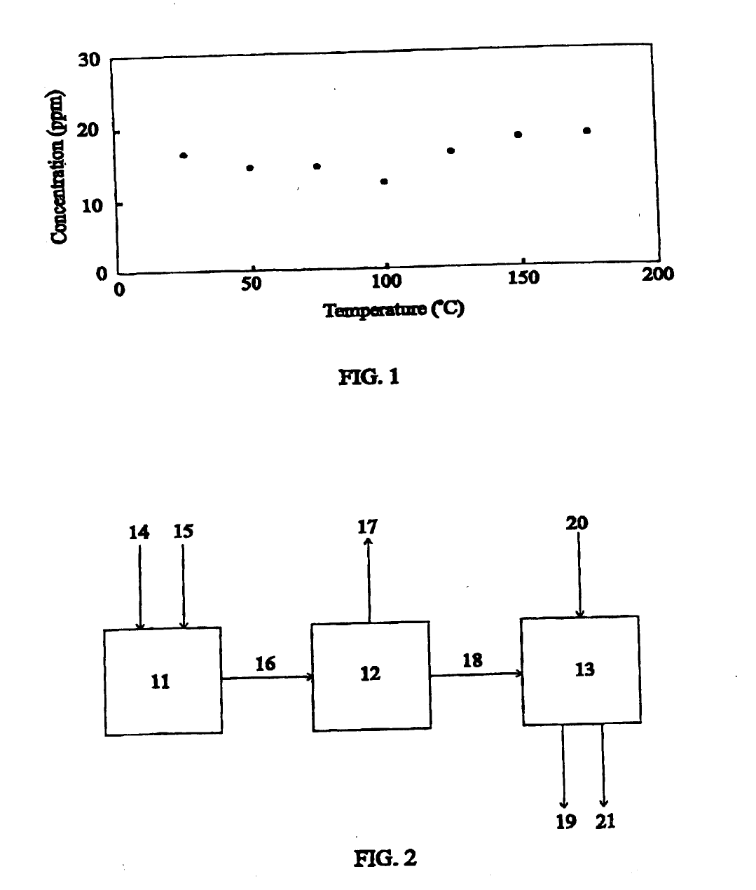

The present invention is based on the discovery that the partitioning of certain useful compounds into liquid water from an essential oil does not increase significantly with temperature. FIG. 1 shows the concentration of borneol in water, which had been in equilibrium with juniper oil at various temperatures. The concentration in the water extract is seen not to change significantly with temperature. A possible explanation is that, although the solubility of borneol in water is increasing with temperature, its solubility in the oil is also increasing. The partition coefficient, which quantifies the partitioning of borneol between water and the oil is approximately the ratio of the solubility in water to that in the oil, and this ratio may therefore not increase much with temperature.

This discovery has led to the development of the process of the invention, for the extraction of sparingly soluble flavor and fragrance compounds from an oil, using water between 0° C. and 100° C., thereby producing a dilute solution in water. Thereafter the extracted compounds may be adsorbed from the water solution on to a solid-phase adsorbent. They may then be recovered from the adsorbent using an organic solvent.

The temperature of the water is suitably below 100° C. Preferably it is not greater than 80° C., more preferably not greater than 50° C., and most preferably not greater than 35° C.

The temperature of the water is preferably at least 10° C., more preferably at least 18° C.

Preferably the water used in step (i) is not pressurized. That is, it is preferably employed at ambient pressure.

Preferably the water and oil are vigorously mixed and then separated, for example by settling or centrifugal action. The water solutions of the desired compounds are dilute, typically 500 parts per million (ppm) or less. The desired compounds need therefore to be concentrated and this is preferably done by trapping them on a solid-phase adsorbent, such as a polymer which may carry suitable chemical groups to which the desired compounds are attracted. The compounds can then be washed off the solid-phase adsorbent by a solvent, particularly one which is acceptable in consumer products, for example ethanol or 1,2-propanediol, suitably at ambient temperature or above, preferably at 20-50° C., to produce a solution of the desired compounds; typically in a solvent-water mixture. This solution may be concentrated further by distillation, preferably under vacuo.

Preferably water at ambient temperature is employed, to contact the oil.

Preferably the process is effected without application of heat during the water-oil mixing stage.

Preferably the process is effected without application of heat to the water, during the stage of contacting a solid which adsorbs the desired compounds with the water solution.

Preferably the process is effected without application of heat during the solvent-addition stage.

Preferably the water is in liquid form throughout the process.

Preferably the entire process is effected at a temperature in the range 10-50° C., more preferably 15-40° C., most preferably at 20-30° C., and, especially, at ambient temperature.

The invention will now be further described, by way of illustration, with reference to the following descriptions and examples.

### DETAILED DESCRIPTION OF THE INVENTION

A schematic diagram of a suitable arrangement for operating the process is shown in FIG. 2. It consists of a mixing chamber 11, a separating device 12, which may be a settling tank or a centrifuge, and a solid-phase adsorption column 13. Water and the oil are fed in (via 14 and 15) into the mixing chamber 11. The mixture then passes (via 16) into the separating device 12. The extracted oil passes out of the separating device (via 17) and may be recycled. The water extract is passed into the solid-phase adsorption column 13 and, after removal of the dissolved compounds, passes out (via 19) and may be recycled. When the solid-phase adsorbent is saturated, the flow of the water extract is stopped. A suitable organic solvent, such as ethanol, is then passed through the solid-phase adsorption column 13 (via 20) and a solution of the extracted compounds is then collected (via 21). The column 13 may be heated whilst the organic solvent is passed through it to a temperature which is below the boiling point of the solvent, preferably 20° C. below the boiling point of the solvent (e.g. 50 to 60° C. when ethanol is employed as a solvent). Conveniently, heating the column typically increases the concentration of extracted compounds in the solution collected from the column.

### DETAILED DESCRIPTION OF THE PREFERRED EMBODIMENTS

### EXAMPLE 1

FIG. 3 shows a chromatogram of a sample of juniper oil, with peak 31 being that of an added internal standard (nonane) used to quantify the results. The large peaks (32, 33 and 34) are monoterpenes (myrcene, β-pinene and limonene, respectively) and the compounds which mostly elute after 18 minutes are the oxygen-containing flavor and fragrance compounds and higher terpenes. The oxygen-containing flavor and fragrance compounds are calculated to be 1.5% by mass of the total oil.

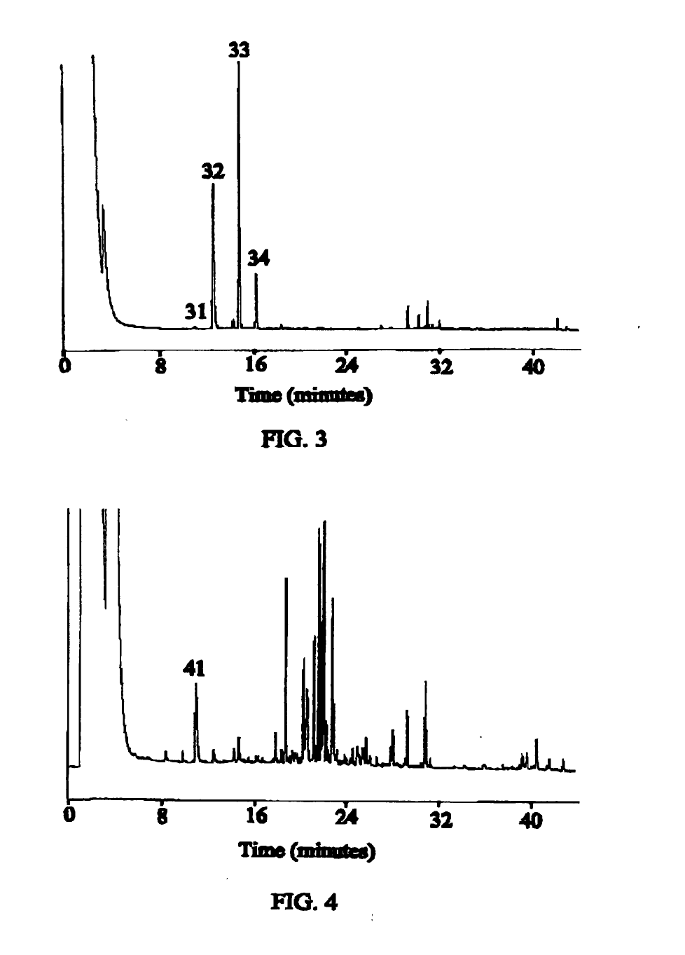

The same juniper oil was extracted with water at 20° C. and the water solution passed through a cross-linked divinylbenzene polystyrene polymer, bonded with amino groups, loaded into a column. The column was subsequently washed with pure ethanol to produce an aromatic solution in which the solvent comprises substantially approximately 90% by volume ethanol and 10% by volume water. A chromatogram of the extract, obtained under identical conditions to that in FIG. 3, is shown in FIG. 4, with peak 41 being that of the internal standard (nonane). As can be seen, the monoterpene peaks are largely missing, while those of the oxygen-containing flavor and fragrance compounds are much enhanced. The solution was found to consist almost entirely (>95%,by mass) of oxygen-containing flavor and fragrance compounds and the total concentration of these compounds in the solution was found to be approximately 2% by mass.

For clarity the y-axis was scaled differently in FIGS. 3 and 4, as is evident from a comparison of the standard peak 31 of FIG. 3 and corresponding peak 41 of FIG. 4.

### EXAMPLE 2

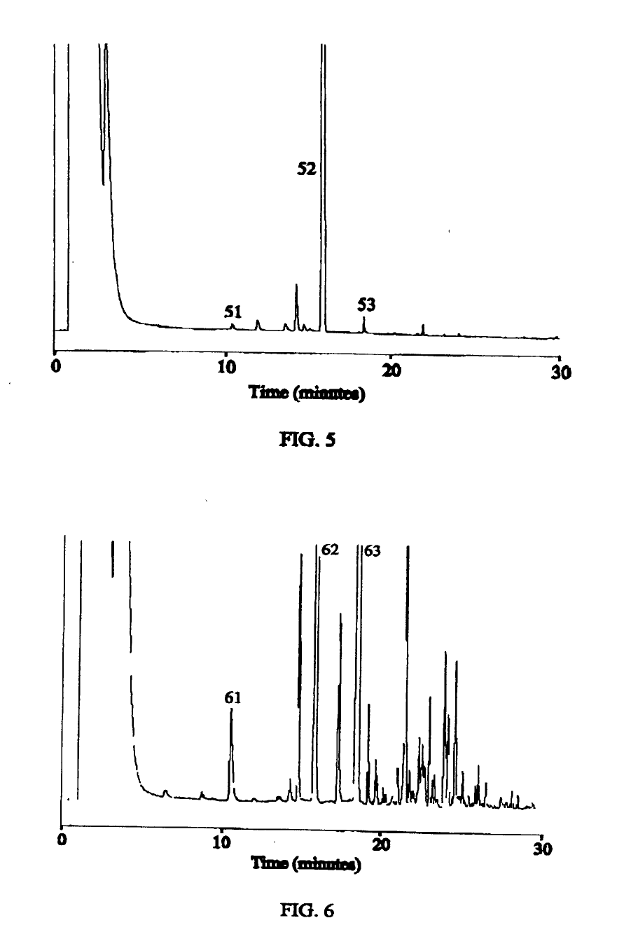

FIG. 5 shows a chromatogram of a sample of orange oil, with peak 51 being an added internal standard (nonane). Peak 52 is the monoterpene limonene and peak 53 is the oxygen-containing compound linalool. The oxygen-containing flavor and fragrance compounds are calculated to be 1.2% by mass of the total oil.

The orange oil was extracted with water at 20° C. and the water solution passed through a cross-linked divinylbenzene polystyrene polymer, bonded with amino groups, loaded into a column. The column was subsequently washed with pure ethanol to produce an aromatic solution in which the solvent comprises substantially approximately 90% by volume ethanol and 10% by volume water. A chromatogram of the extract, obtained under identical conditions to that in FIG. 5, is shown in FIG. 6, with peak 61 being that of the internal standard (nonane). As can be seen, the limonene peak 62 is relatively small, while those of the oxygen-containing flavor and fragrance compounds are much enhanced, for example the linalool peak 63. The solution was found to consist largely (>90% by mass) of oxygen-containing flavor and fragrance compounds and the total concentration of these compounds in the solution was found to be 1.2% by mass.

For clarity the y-axis was scaled differently in FIGS. 5 and 6, as is evident from a comparison of the standard peak 51 of FIG. 5 and corresponding peak 61 of FIG. 6.

The present invention is described above as it applies to preferred embodiments. It is not intended that the present invention be limited to the described embodiments. It is intended that the claims defining the invention cover all alternatives, modifications and equivalents which may be included within the spirit and scope of the invention.

We claim:

1. A method for the extraction of sparingly water-soluble flavor and fragrance compounds from a natural oil, the method comprising the steps of
(i) contacting the natural oil with liquid water at a temperature in the range from 0 to 100° C. to form an aqueous solution of the flavor and fragrance compounds,
(ii) contacting the aqueous solution of the flavor and fragrance compounds with a solid which adsorbs the flavor or fragrance compounds, and
(iii) contacting the solid carrying said flavor or fragrance compounds with an organic solvent which washes the flavor or fragrance compounds from the solid to provide a solution of the flavor or fragrance compounds in the organic solvent.

2. A method as claimed in claim 1, wherein the flavor or fragrance compounds are oxygen-containing flavor or fragrance compounds.

3. A method as claimed in claim 1, wherein the water in step (i) is not at ambient pressure.

4. A method as claimed in claim 1, wherein the temperature of the water in step (i) is at least 10° C.

5. A method as claimed in claim 4, wherein the temperature of the water in step (i) is at least 18° C.

6. A method as claimed in claim 1, wherein the temperature of the water in step (i) does not exceed 80° C.

7. A method as claimed in claim 6, wherein the temperature of the water in step (i) does not exceed 50° C.

8. A method as claimed in claim 7, wherein the temperature of the water in step (i) does not exceed 32° C.

9. A method as claimed in claim 1, wherein the entire method is carried out at a temperature in the range 10-50° C.

10. A method as claimed in claim 9, wherein the entire method is carried out at a temperature in the range 15-40° C.

11. A method as claimed in claim 10, wherein the entire method is carried out at a temperature in the range 20-30° C.

12. A method as claimed in claim 11, wherein the entire method is carried out at ambient temperature.

13. A method as claimed in claim 1, wherein the solubility of the desired compounds in the water is 500 parts per million or less.

14. A method as claimed in claim 1, wherein the solid is a polymer carrying functional groups able to capture the desired compounds.

15. A method as claimed in claim 1, wherein the organic solvent is an alcohol.

16. A method as claimed in claim 15, wherein the alcohol is a monohydric, dihydric or trihydric alcohol having up to 6 carbon atoms.

17. A method as claimed in claim 15, wherein the alcohol is miscible with water.

18. A method as claimed in claim 17, wherein the alcohol is selected from ethanol and 1,2-propanediol.

19. A method as claimed in claim 1, wherein the natural oil comprises substantially water-insoluble hydrocarbons.
